(19) United States
(12) Patent Application Publication
(10) Pub. No.: US 2017/0362055 A1
(43) Pub. Date: Dec. 21, 2017

(54) REDUNDANT SAFETY CIRCUIT

(71) Applicants: Ari KATTAINEN, Hyvinkaa (FI); Juha-Matti AITAMURTO, Helsinki (FI); Claus INGMAN, Helsinki (FI); Ferenc STAENGLER, Hyvinkaa (FI); Gergely HUSZAK, Helsinki (FI); Tuomas NYLUND, Helsinki (FI)

(72) Inventors: Ari KATTAINEN, Hyvinkaa (FI); Juha-Matti AITAMURTO, Helsinki (FI); Claus INGMAN, Helsinki (FI); Ferenc STAENGLER, Hyvinkaa (FI); Gergely HUSZAK, Helsinki (FI); Tuomas NYLUND, Helsinki (FI)

(73) Assignee: Kone Corporation, Helsinki (FI)

(21) Appl. No.: 15/609,496

(22) Filed: May 31, 2017

(30) Foreign Application Priority Data
Jun. 17, 2016 (EP) 16174900.7

(51) Int. Cl. B66B 5/00; B66B 1/28; B66B 5/02; B66B 9/00

(52) U.S. Cl. CPC B66B 5/0031; B66B 9/00; B66B 1/28; B66B 5/02

(57) ABSTRACT

In modern elevators, safety circuits are used for preventing the operation of an elevator having possibly safety related problems. Sometimes the problem is in the safety circuit itself, and the operation could be continued. In a disclosed arrangement, groups of at least two independent safety circuits are used. The operation of the elevator can be continued in the case where one safety circuit in each group indicates that there is a possible problem. Thus, one deficient safety switch in one safety circuit does not prevent the operation.

### DESCRIPTION OF BACKGROUND

This application claims priority to European Patent Application No. EP16174900.7 filed on Jun. 17, 2016, the entire contents of which are incorporated herein by reference.

The following description relates to a redundant safety circuit arrangement in an elevator. Particularly, the following description relates to improving availability of an elevator by using redundant safety circuits.

Modern elevators are equipped with safety circuits. The purpose of such circuits is to prevent the operation of an elevator that may have faults or defects that can cause safety related problems that can be dangerous to passengers. For example, elevator doors are equipped with safety devices that are configured to monitor that doors are closed before the elevator starts moving. These safety devices are typically regulated by standards, such as the European standard EN 81-20, and sometimes also by local law and practice.

When a fault has been detected, the elevator can be closed and further journeys will be prevented. Then, a maintenance person will be called and the elevator will be repaired. Smaller buildings often have only one elevator per stairway. Thus, in case of elevator breakage, for example handicapped persons may not enter or exit the desired floor or the whole building. In bigger buildings there may be more than one elevator available, so that passengers are not trapped to their floors. However, also in bigger buildings high availability rates are desired, because it reduces the need to build backup capacity. Backup capacity is expensive and it requires space that could be used otherwise.

When the elevator has a possibly safety related issue, it is necessary to call the maintenance person and check the issue. If the call was correct, the elevator operation was prevented for a reason. The called maintenance person will repair the elevator so that it can be used safely again. If the call was incorrect, for example a false alarm, or the issue was not safety related even if a safety related alarm was launched, the operation of the elevator has been prevented without a real reason. Furthermore, calling a maintenance person urgently incurs unnecessary costs. Thus, the service level could have been maintained by operating the elevator, even if a safety related alarm was issued, by ignoring it and repairing it later. Such a situation may occur, for example, when the defect is in a safety circuit for detecting safety related faults. For example, a safety device monitoring doors may incorrectly indicate that the doors are still open, even if they were correctly closed. However, presently a safety related alarm cannot be ignored, because ignoring a real safety related alarm might have serious consequences.

It is obvious that there is always a need for improving the capacity and reliability of elevators. Thus, there is also a need for detecting situations wherein the operation of an elevator could be continued in case of a safety alarm, when the safety alarm could be considered as a false alarm.

### SUMMARY

A redundant safety circuit arrangement is disclosed. In modern elevators, safety circuits are used for preventing the operation of an elevator possibly having safety related problems. Sometimes the problem is in the safety circuit itself and the operation could be continued. In the disclosed arrangement, groups of at least two independent safety circuits are used. The operation of the elevator can be continued also in cases where one safety circuit in each group indicates that there is a possible problem. Thus, one deficient safety switch in one safety circuit does not prevent the operation.

A method for operating an elevator is disclosed. The method comprises receiving a signal indicating start of a journey; receiving signals from at least one safety circuit group, wherein at least one safety circuit group comprises at least two safety circuits; and allowing operation of said elevator when each of the at least one safety circuit group has at least one safety circuit indicating that said elevator is safe.

In an embodiment the method further comprises launching an alarm when at least one safety circuit in any of the at least one group indicates that the elevator is not safe. In an embodiment said signals are received from an elevator car. In another embodiment signals are received from shaft side. In a further embodiment signals are received from both elevator car and shaft side.

In another embodiment said signals are received at a plurality of safety controllers. In a further embodiment said signals are received for each group at a safety controller dedicated to said group and each of safety controllers in said plurality of safety controllers is configured to allow or prevent the operation of said elevator.

In a further embodiment the method disclosed above is implemented as a computer program. The computer program is configured to perform the method when executed in a computing device.

In an embodiment an elevator is disclosed. The elevator comprises a first safety circuit; a second safety circuit, wherein said first and second safety circuits are configured to monitor the same elevator components; and at least one safety controller, wherein said at least one safety controller is configured to allow operation of said elevator when at least one safety circuit indicates that the elevator is safe to use.

In a further embodiment the elevator further comprises an elevator car and said first and second safety circuits are in said elevator car. In another embodiment the elevator further comprises an elevator shaft and said first and second safety circuits are in said elevator shaft. In another embodiment the first and second safety circuits are arranged as a first group. In a further embodiment the elevator further comprises a second group comprising at least two safety circuits.

In a further embodiment the first and second groups are connected to at least one safety controller each. In another embodiment the first and second groups are connected to the same safety controller. In another embodiment the safety controllers are configured to allow the operation of the elevator when each of said groups comprises at least one safety circuit indicating that the elevator is safe to use.

The benefits of the described embodiments include increasing the availability of an elevator. When the defect is not safety related but safety circuit related, the elevator can be operated and the passengers are transported from one floor to another. The increase of availability improves the user experience of the elevators. When the availability of the elevators is increased, it is not necessary to build as much back up capacity. This may lead to cost savings, when smaller and fewer elevators are needed. This also reduces operating costs and the use of electricity, if smaller elevators can be chosen.

A further benefit of the embodiments disclosed above is the reduction in the maintenance cost. As the possible defect is not safety related and the elevator must not be switched off, the maintenance visit may be scheduled more freely and prioritized into a lower urgency class. This will reduce the need of maintenance persons in the emergency service, and will also reduce the overall maintenance cost.

A further benefit of the embodiments disclosed above is that they can be easily retrofitted to old elevators. This allows increasing the overall capacity in older elevators by increasing the availability of the elevators.

### BRIEF DESCRIPTION OF THE DRAWINGS

The accompanying drawings, which are included to provide a further understanding of the redundant safety circuit and constitute a part of this specification, illustrate embodiments and together with the description help to explain the principles of the redundant safety circuit. In the drawings:

FIG. 1 is a block diagram of an example embodiment of the present redundant safety circuit,

FIG. 2 is a block diagram of an example embodiment of the present redundant safety circuit,

FIG. 3 is a flow chart of a method according to an example embodiment.

### DETAILED DESCRIPTION

Reference will now be made in detail to the embodiments, examples of which are illustrated in the accompanying drawings.

The embodiments disclosed in the following description are used in elevators. In the embodiments, a plurality of safety devices form a safety circuit. The plurality of safety devices are serially connected switches, so that when one switch is open the whole safety circuit is open, and the elevator comprising only one safety circuit will not run. Different types of devices, switches and circuit configurations are known.

Typically, the circuit is connected to a safety repeater that is configured to transmit information further by using data transmission means. The data transmission means can be, for example, a commonly used RS-485 serial connection or a wireless transmitter configured to transmit similar information. The safety repeater may have one or more transmitters that are used to transmit safety information to a safety controller that can prevent the operation of the elevator.

In the following embodiments, the safety circuit is duplicated. Thus, every safety related part of an elevator is connected to two different safety circuits. For example, each door may have two different safety switches that are in a closed state when the doors are closed. The safety switches are connected to the respective circuits.

Instead of two separate switches, it is possible to use special purpose switches that have connectors for two independent circuits. This may be particularly beneficial when older elevators are renovated so that the space reserved for switches does not need to be changed but a switch of the same size can be used with double wiring. A similar benefit may be achieved by using a safety switch unit having two independent safety switches, where the safety switch unit has same dimensions as earlier conventional safety switches.

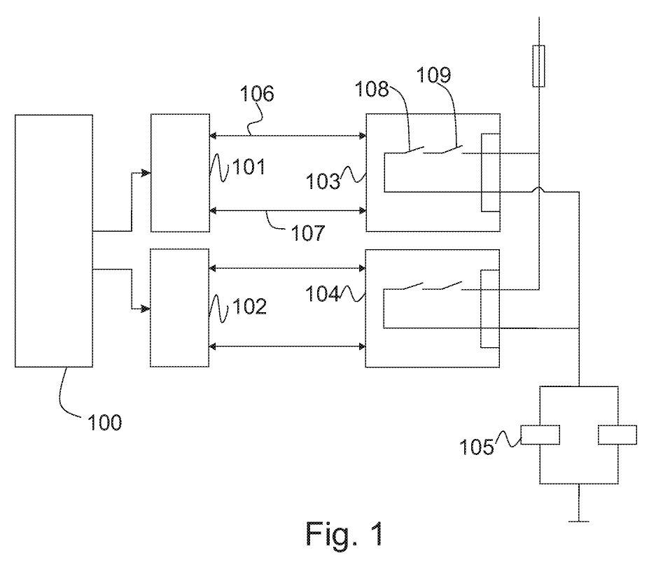

In FIG. 1, an embodiment comprising a safety repeater and safety controller for each safety circuit is disclosed. However, it is possible to use only one repeater having a sufficient number of transmission channels. Correspondingly, it is possible to use only one safety controller, provided that it can deal with each safety circuit independently.

The safety controller or a plurality of safety controllers are configured so that the operation of an elevator is not prevented when one safety circuit is open. In the following embodiments, two circuits are used; however, also three or more can be used, provided that they are configured according to the principles of the following embodiments.

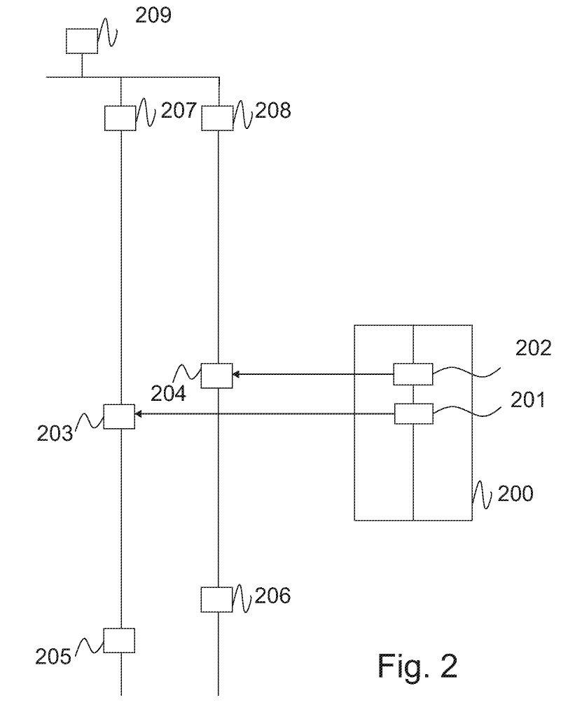

In FIG. 1, a block diagram of an embodiment of a redundant safety circuit is disclosed. In FIG. 1, an embodiment disclosing a safety circuit of an elevator car is disclosed. FIG. 2 discloses a similar arrangement for an elevator shaft side safety circuit. The two embodiments can be implemented independently or together.

In FIG. 1, an elevator car 100 is disclosed. The elevator car comprises two safety circuits that are connected to a first safety repeater 101 and a second safety repeater 102, respectively. The safety repeaters of FIG. 1 are configured to transmit the state of the safety circuit in two independent transmissions.

The first safety repeater 101 is configured to send a first safety signal 106 and a second safety signal 107 to a safety controller 103. Corresponding signals are sent from the second safety repeater 102 to a second safety controller 104. The first safety signal 106 and second safety signal 107 do not need to be identical; however, the signals are used to control a first safety controller switch 108 or a second safety controller switch 109 in accordance with the respective safety signals. Thus, if the first or second safety signal indicates that there is a safety related fault, the safety controller 103 is set into a state that would prevent the operation of the elevator if the state was derived from a sole safety circuit. In the embodiment of FIG. 1, the operation of the second safety repeater and the second safety controller are identical to the first ones.

However, in the embodiment of FIG. 1 the two safety controllers 103 and 104 are configured in a manner that it is enough if one of the safety controllers allows main contactors 105 to operate the elevator. Thus, the availability of the elevator monitored is increased, because the operation of the elevator is not prevented, for example, when one safety switch is deficient.

In FIG. 2, a block diagram of an embodiment implemented on the shaft side is disclosed. In FIG. 1, an embodiment implemented on the elevator car side was disclosed. The embodiment of FIG. 2 shares the same basic principles. The embodiments of FIG. 1 and may be implemented fully independently and stand alone; however, it is often beneficial to have both.

In FIG. 2, an elevator landing door 200 is illustrated. The landing door is located on a floor so that people waiting in a lobby are behind the door until the elevator car has stopped and it is safe to enter. The elevator door 200 has been equipped with two independent safety switches 201 and 202. As can be seen from the figure, they are connected to their own safety circuits through floor controllers 203 and 204, respectively. When the door 200 is open, both safety switches 201 and 202 are also open, and the floor controllers 203 and 204 are configured to set the safety circuit open. When the doors are closed, also the safety switches 201 and 202 should close, and the safety circuit should be set to indicate that the doors are closed.

Floor controllers 205 and 206 are shown in the figure, and they belong to another floor and work accordingly. The floor controllers form a long circuit that comprises at least all floors where the elevator has landing doors. In the embodiment of FIG. 2, there are two of these circuits. Each floor comprises a pair of controllers. Instead of a pair of controllers, it is possible to provide a controller having the possibility to connect to two independent circuits.

At the end of the circuit there are two independent safety repeaters 207 and 208. These safety repeaters are configured to send safety information to a safety controller 209. The safety controller is connected to the elevator system in a manner that it can prevent the operation of the elevator. In the embodiment of FIG. 2 it is configured to do so when both safety repeaters 207 and 208 indicate that the safety circuit is open. If only one safety circuit is open, then the operation of the elevator may be continued.

In the above embodiments, the operation is allowed when at least one safety circuit is closed and indicates that the elevator is safe to use. It is assumed that the second safety circuit is open because of a fault in the circuit and not in the elevator. Similar principles may be used if more than two circuits are used.

The embodiments disclosed above may be implemented to use one and the same safety controller. In such case, the elevator car side and the shaft side are treated independently, and in order to be operable, both the shaft side and the elevator car side must be safe.

In the embodiments described above, the safety repeaters are configured to transmit information only to the safety controllers. However, it is possible that the repeaters are configured to transmit information also to additional devices, such as a controller that can provide an alert to the maintenance staff. When one safety circuit indicates a fault, it needs to be checked, even if the operation could be continued. In such case, the maintenance person can arrive at the elevator after the rush hour, so that the maintenance break does not disturb passengers that much.

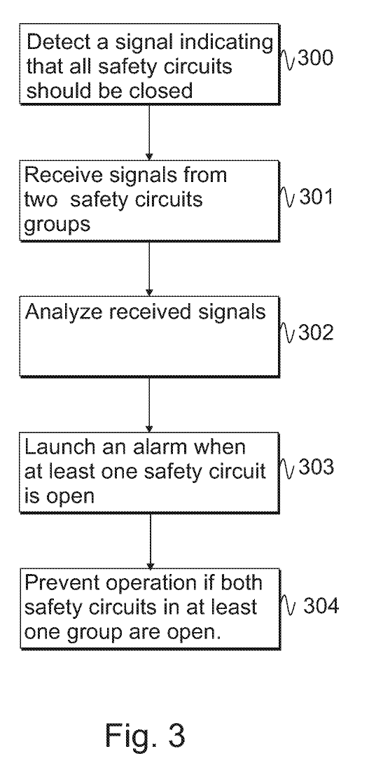

In FIG. 3, a method according to an embodiment is disclosed. The method is performed in an apparatus similar to the safety controllers of FIGS. 1 and 2. In the following description, an example with only one safety controller is described. In the example, two elevator side safety circuits form a first safety group and two shaft side safety circuits form a second safety group. Each of the safety circuits is connected to the safety controller.

The method is initiated by detecting a signal indicating that all safety circuits should be closed, step 300. This signal is provided when it is assumed that the elevator is ready to start a journey according to placed calls. At this moment, the doors should be closed and everything should be ready for the start. The safety circuits are used to check if this is really the case.

In order to do the check, signals from the safety circuits are received at the safety controller, step 301. The safety controller is configured to receive four different signals from four independent safety circuits arranged into two groups.

After receiving, each of the signals is analyzed independently, step 302. The signal may be of a binary type that indicates only that the circuit is open, or it may comprise more information, for example about the location where the circuit is open. The main information for the purpose of increasing availability is the information indicating if the elevator is safe to use. Each of the received signals is analyzed accordingly.

If any of the safety circuit signals indicate that the elevator is not safe to use, an alarm for a maintenance person is sent, step 303. The alarm may include an indication about the location of the problem; however, this is not necessary.

In the example of FIG. 3, there are two safety circuits in each group of safety circuits. If there are two safety circuits open but they belong to different groups, the operation may be continued; however, it is possible to send a special type of alarm. If there is a group where both safety circuits are open, or indicating an unsafe situation, the operation of the elevator must be prevented, step 304. As the safety circuits are fully independent, it is unlikely that there are two independent safety circuit defects, and it is likely that there is a safety related problem in the elevator.

In the method of FIG. 3, two groups comprising two safety circuits each are disclosed. However, it is possible that only one group comprises two safety circuits and the other one comprises only one safety circuit. In such a situation, the operation of the elevator must be prevented in the case where the only one safety circuit in the group indicates a possible defect. The operation may be continued only if the group having two safety circuits has one safety circuit indicating a possible defect.

The above mentioned method may be implemented as computer software which is executed in a computing device able to communicate with external devices and connectable to at least four safety circuits. When the software is executed in a computing device, it is configured to perform the above described inventive method. The software is embodied on a computer readable medium so that it can be provided to the computing device, such as the safety controller 209 of FIG. 2.

As stated above, the components of the exemplary embodiments can include a computer readable medium or memories for holding instructions programmed according to the teachings of the present embodiments and for holding data structures, tables, records, and/or other data described herein. The computer readable medium can include any suitable medium that participates in providing instructions to a processor for execution. Common forms of computer-readable media can include, for example, a floppy disk, a flexible disk, a hard disk, a magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, a Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the redundant safety circuit may be implemented in various ways. The redundant safety circuit and its embodiments are thus not limited to the examples described above; instead they may vary within the scope of the claims.

1. A method for operating an elevator which method comprises:
receiving a signal indicating start of a journey;
receiving signals from at least one safety circuit group, wherein at least one safety circuit group comprises at least two safety circuits; and
allowing operation of said elevator when each of the at least one safety circuit group has at least one safety circuit indicating that said elevator is safe.

2. A method according to claim 1, wherein said method further comprises launching an alarm when at least one safety circuit in any of the at least one group indicates that the elevator is not safe.

3. A method according claim 1, wherein receiving said signals from an elevator car.

4. A method according to claim 1, wherein receiving said signals from a shaft side.

5. A method according to claim 1, wherein receiving said signals at a plurality of safety controllers.

6. A method according to claim 5, wherein receiving said signals for each group at a safety controller dedicated to said group and each of safety controllers in said plurality of safety controllers is configured to allow or prevent the operation of said elevator.

7. A computer program, wherein said computer program is configured to perform the steps of claim 1 when executed in a computing device.

8. An elevator comprising:
a first safety circuit;
a second safety circuit, wherein said first and second safety circuits are configured to monitor the same elevator components; and
at least one safety controller, wherein said at least one safety controller is configured to allow operation of said elevator when at least one safety circuit indicates that the elevator is safe to use.

9. The elevator according to claim 8, wherein said elevator comprises an elevator car and said first and second safety circuits are in said elevator car.

10. The elevator according to claim 8, wherein said elevator comprises an elevator shaft and said first and second safety circuits are in said elevator shaft.

11. The elevator according to claim 8, wherein said first and second safety circuits are arranged as a first group.

12. The elevator according to claim 11, wherein the elevator further comprises a second group comprising at least two safety circuits.

13. The elevator according to claim 12, wherein said first and second groups are connected to at least one safety controller each.

14. The elevator according to claim 12, wherein said first and second groups are connected to the same safety controller.

15. The elevator according to claim 13, wherein the safety controllers are configured to allow the operation of the elevator when each of said groups comprises at least one safety circuit indicating that the elevator is safe to use.
